(19) United States
(12) Patent Application Publication
(10) Pub. No.: US 2014/0024485 A1
(43) Pub. Date: Jan. 23, 2014

(54) DRIVE UNIT FOR A BELT DRIVE SYSTEM

(71) Applicant: ABB Schweiz AG, Baden (CH)

(72) Inventor: Urs MAIER, Aristau (CH)

(73) Assignee: ABB Schweiz AG, Baden (CH)

(21) Appl. No.: 14/033,850

(22) Filed: Sep. 23, 2013

Related U.S. Application Data
(63) Continuation of application No. PCT/EP2012/053995, filed on Mar. 8, 2012.

(30) Foreign Application Priority Data
Mar. 23, 2011 (EP) 11159435.4

(51) Int. Cl. F16H 55/36

(52) U.S. Cl. CPC F16H 55/36
USPC 474/166

(57) ABSTRACT

A drum shaft of a drive unit with a gearless drive for a belt drive system is disclosed having a hollow shaft. The gearless drive can include a bearing-free rotor shaft and the hollow shaft can include a radial end face on an end which faces the rotor shaft. An outside diameter of said end face can be the same size or smaller than an outside diameter of the hollow shaft. The hollow shaft is connected to the rotor shaft by the end face.

### RELATED APPLICATION(S)

This application claims priority as a continuation application under 35 U.S.C. §120 to PCT/EP2012/053995, which was filed as an International Application on Mar. 8, 2012, designating the U.S., and which claims priority to European Application No. 11159435.4 filed in Europe on Mar. 23, 2011. The entire contents of these applications are hereby incorporated herein by reference in their entireties.

### FIELD

The present disclosure relates to belt drive systems. According to an exemplary embodiment, a drive unit for a belt drive system is disclosed having a driving drum, a drum shaft which is connected to the driving drum and mounted at both ends of the driving drum, and a gearless drive which has a bearing-free rotor shaft.

### BACKGROUND INFORMATION

Belt drive systems, which are also known as conveyor belt systems or belt conveyors, can be used for conveying unit loads or bulk material in mining and in the industry. DE 847,427 describes an endless belt, which is mounted so as to be rolling in a horizontal manner and is driven by a driving drum which is connected to a drum shaft and is set into a rotational movement by means of a drive.

To transmit driving power of more than 2 MW to the driving drum, gearless drives can be used. A rotor of a gearless drive can be mounted directly on a bearing-free rotor shaft. A stator, which is connected to a base plate, is arranged outside around the rotor as a counterpart. The bearing-free rotor shaft is connected to the drum shaft.

“Advanced drive system saves up to 20% energy”, a Siemens brochure, describes a drive unit for a belt drive system having a driving drum, a drum shaft and a gearless drive with a bearing-free rotor shaft. The drum shaft can have stay-bolts which are inserted through corresponding bores in an inside flange of the rotor shaft and can be secured on the rear side of the inside flange by means of nuts. The solution poses issues for long-term operation as a result of the high tolerance demands and can be difficult to handle.

The connection between the drum shaft and the rotor shaft in gearless drives of mining conveyor systems can use one continuous shaft instead of a separate drum shaft and rotor shaft. The heavier weight of the continuous shaft in comparison with the weights of the separate shafts and the lack of an ability to separate them, however, can produce issues in connection with the assembly, disassembly and protection of the system.

A flange connection can also be used. With the use of a flange connection, a flange of the drum shaft on the rotor shaft end has to be releasably mounted, for example, by shrinking the flange onto the drum shaft in order to ensure assembly and disassembly of a drum bearing rotor on the rotor shaft end. As a result of an additional face on an outside surface of the drum shaft for the shrinking-on process, the drum shaft becomes longer and the space for the drive increases. This can impact use underground or in other locations of use where the space available is restricted, and additionally can lead to reduced rigidity and resultant issues with deflexion of the rotor shaft.

### SUMMARY

A belt drive system is disclosed comprising: a drive unit having a driving drum; a drum shaft which is configured to be connected to the driving drum and configured to be mounted at both ends of the driving drum; and a gearless drive which has a bearing-free rotor shaft, wherein the drum shaft has a hollow shaft, which hollow shaft is configured to be connected to the rotor shaft by an end face of the hollow shaft which faces the rotor shaft, and wherein the end face has an outside diameter which is a same size as or smaller than an outside diameter of the hollow shaft.

A belt drive system drive unit is disclosed, the drive unit comprising: a driving drum; a drum shaft configured to be connected to the driving drum and configured to be mounted at both ends of the driving drum; and a gearless drive which has a bearing-free rotor shaft, wherein the drum shaft has a hollow shaft, which hollow shaft is configured to be connected to the rotor shaft by an end face of the hollow shaft which faces the rotor shaft, and wherein the end face has an outside diameter which is a same size as or smaller than an outside diameter of the hollow shaft.

A driving drum unit for a belt drive system is disclosed, the driving drum unit comprising: a driving drum; and a drum shaft, which is configured to be connected to the driving drum and configured to be mounted at both ends of the driving drum and connectable to a bearing-free rotor shaft of a gearless drive, and wherein the drum shaft has a hollow shaft which is connectable to the rotor shaft by an end face which faces the rotor shaft, and wherein the end face has an outside diameter which is a same size or smaller than an outside diameter of the hollow shaft.

### BRIEF DESCRIPTION OF THE DRAWINGS

The disclosure is explained below with reference to exemplary embodiments shown in the drawings. In the drawings:

FIG. 1 shows a section in the axial direction of an exemplary driving drum unit with a gearless drive; and

FIG. 2 shows a section in the axial direction of a reinforcement of an exemplary hollow shaft.

### DETAILED DESCRIPTION

In accordance with an exemplary embodiment, a drive unit for a belt drive system is disclosed having a driving drum, a drum shaft and a gearless drive, which drive unit can use less space and can have increased rigidity.

In accordance with an exemplary embodiment, a drive unit is disclosed for a belt drive system having a driving drum unit, a driving drum unit and the use of a hollow shaft as a drum shaft for the drive unit.

In accordance with an exemplary embodiment, a drum shaft is disclosed, which at least in part can be a hollow shaft. The hollow shaft can include a radial end face on an end which faces the rotor shaft. The hollow shaft can be connected to the rotor shaft by means of the end face. An outside diameter of the end face can be the same size as or smaller than an outside diameter of the hollow shaft. As a result, the end face can be positioned directly onto a rotor-end drum shaft bearing in an encompassing manner.

An exemplary embodiment relates to a drive unit where the drum shaft, in addition to the hollow shaft, has a further part in the form of a connecting shaft. The connecting shaft can be a solid shaft with a diameter which can be smaller than the outside diameter of the hollow shaft. The hollow shaft and the connecting shaft can be connected together on an end of the hollow shaft which is located opposite the rotor shaft and, in the case of rotation about a rotational axis of the drum shaft, form one unit. In an exemplary embodiment, one drum shaft bearing can be arranged at each end of the driving drum on the hollow shaft and the connecting shaft. As a result, a smaller drum shaft bearing can be used on an end of the driving drum which can be remote from the rotor shaft.

An exemplary embodiment relates to a drive unit where the hollow shaft, in the region of the connection to the rotor shaft, has a circular reinforcement which can be designated as strutting or stiffening. As a result, improved force transmission from the rotor shaft to the hollow shaft can be achieved.

An exemplary embodiment relates to a drive unit where the reinforcement of the hollow shaft can be positioned such that it forms at least part of the end face which faces the rotor shaft. The connecting elements can be positioned both in a ring which is formed by a lateral surface of the hollow shaft and in the remaining end face. As a result, better introduction of force onto the hollow shaft can be made.

An exemplary embodiment relates to a drive unit where the diameter of the hollow shaft can be smaller than a diameter of the driving drum and greater than a diameter of the rotor shaft. As a result, a small a small drum shaft bearing can be used for the hollow shaft.

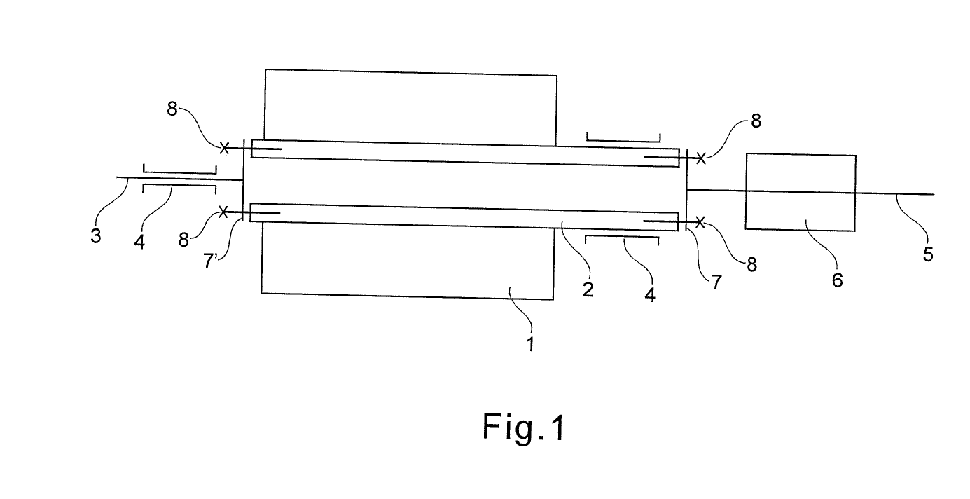

FIG. 1 shows a section in the axial direction, transversely with respect to the running direction of the belt, of a driving drum unit of a belt drive system and a gearless drive. A driving drum 1 rests on a drum shaft and can be mounted at both ends by drum shaft bearings 4. The driving drum can include a hollow shaft 2 and a connecting shaft 3, which can be connected to the hollow shaft 2 by way of bolts 8 by means of a flange 7′ of the connecting shaft 3 and an end face of the hollow shaft 2 which faces the connecting shaft 3. The connecting shaft 3 can have a smaller diameter than the outside diameter of the hollow shaft 2. A drum shaft bearing 4 can be situated in each case on the hollow shaft 2 and the connecting shaft 3. On an end of the hollow shaft 2, which can be located opposite the connecting shaft 3, a bearing-free rotor shaft 5 can be connected by way of bolts 8 by means of a flange 7 of the rotor shaft 5 and an end face of the hollow shaft 2 which faces the rotor shaft 5. The rotor 6 can be located on the rotor shaft 5. A stator, which is not shown in FIG. 1, can be arranged on the outside around the rotor 6 as a counterpart.

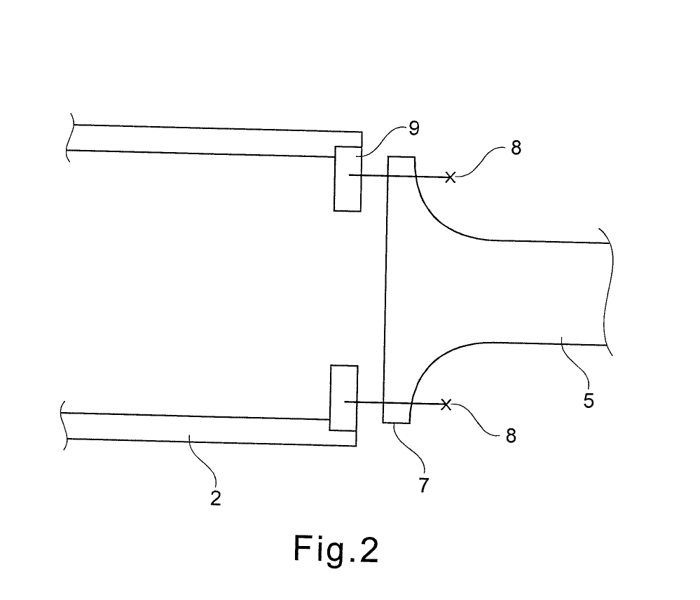

FIG. 2 shows a section in the axial direction of a view of a detail of a reinforcement 9 of the hollow shaft 2. The circular ring-shaped reinforcement 9 can be fixedly connected to the hollow shaft 2 and can be positioned such that said latter together with an edge of the hollow shaft 2 which faces the rotor shaft 5 forms an even end face in a radial plane. A face of the flange 7 of the rotor shaft 5 which faces the hollow shaft 2 can lie on said end face and forms a contact face for the connection between the hollow shaft 2 and the rotor shaft 5. Bolts 8 can fix the rotor shaft 5 on the reinforcement 9.

In an exemplary embodiment, the connecting shaft 3 does not forcibly have to be present. For example, the drum shaft can have only one hollow shaft. In an exemplary embodiment, identical drum shaft bearings on both ends can be used. As a result, the bearing load can be the same. For example, there is no asymmetrical deformation on the driving drum 1 and a clean run of the conveyor belt can be obtained. In an exemplary embodiment, the hollow shaft 2 does not have to be continuous. The hollow shaft 2 can also be flanged or fastened in another manner at the end face of the driving drum. Instead of by means of a flange 7, the rotor shaft 5 can also be inserted directly through the rotor shaft 5 by means of stay-bolts, which are inserted into the reinforcement 9 of the hollow shaft 2, and can be secured on a rear side of the rotor shaft 5. In place of bolts for fastening, other releasable connecting elements can be used, such as, for example, rivets. The geometry of the reinforcements 9 can be selected in an arbitrary manner. For example, rotationally-symmetrical geometries can be used since they do not produce any unbalance of the drum shaft. The position of the reinforcement 9 does not have to be forcibly directly on an end of the hollow shaft 2. For example, the reinforcement 9 can be placed in a region close to the flange inside the hollow shaft 2.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCES

1 Driving drum

2 Hollow shaft

3 Connecting shaft

4 Drum shaft bearing

5 Rotor shaft

6 Rotor

7,7′ Flange

8 Bolt

9 Reinforcement

What is claimed is:

1. A belt drive system comprising:
a drive unit having a driving drum;
a drum shaft which is configured to be connected to the driving drum and configured to be mounted at both ends of the driving drum; and
a gearless drive which has a bearing-free rotor shaft, wherein the drum shaft has a hollow shaft, which hollow shaft is configured to be connected to the rotor shaft by an end face of the hollow shaft which faces the rotor shaft, and wherein the end face has an outside diameter which is a same size as or smaller than an outside diameter of the hollow shaft.

2. The belt drive system as claimed in claim 1, wherein, close to the hollow shaft, the drum shaft comprises:
a connecting shaft produced from solid material with a smaller diameter than the outside diameter of the hollow shaft, and wherein the hollow shaft and the drum shaft are connected together on an end of the hollow shaft which is remote from the rotor shaft, and wherein a drum shaft bearing on the rotor shaft end is configured to guide the hollow shaft and a drum shaft bearing which is remote from the rotor shaft is configured to guide the connecting shaft.

3. The belt drive system as claimed in claim 1, wherein the hollow shaft comprises:
a circular reinforcement in a region of the connection to the rotor shaft.

4. The belt drive system as claimed in claim 3, wherein the reinforcement forms at least in part the end face of the hollow shaft which faces the rotor shaft.

5. The belt drive system as claimed in claim 1, wherein the outside diameter of the hollow shaft is smaller than an outside diameter of the driving drum and is greater than a diameter of the rotor shaft.

6. A belt drive system drive unit, the drive unit comprising:
a driving drum;
a drum shaft configured to be connected to the driving drum and configured to be mounted at both ends of the driving drum; and
a gearless drive which has a bearing-free rotor shaft, wherein the drum shaft has a hollow shaft, which hollow shaft is configured to be connected to the rotor shaft by an end face of the hollow shaft which faces the rotor shaft, and wherein the end face has an outside diameter which is a same size as or smaller than an outside diameter of the hollow shaft.

7. The belt drive system drive unit as claimed in claim 6, wherein, close to the hollow shaft, the drum shaft comprises:
a connecting shaft produced from solid material with a smaller diameter than the outside diameter of the hollow shaft, and wherein the drum shaft and the hollow shaft are configured to be connected together on an end of the hollow shaft which is remote from the rotor shaft, a drum shaft bearing on the rotor shaft end configured to guide the hollow shaft and a drum shaft bearing which is remote from the rotor shaft configured to guide the connecting shaft.

8. The belt drive system drive unit as claimed in claim 6, wherein the hollow shaft comprises:
a circular reinforcement in a region of the connection to the rotor shaft.

9. The belt drive system drive unit as claimed in claim 8, wherein the reinforcement forms at least in part the end face of the hollow shaft which faces the rotor shaft.

10. The belt drive system drive unit as claimed in claim 6, wherein the outside diameter of the hollow shaft is smaller than an outside diameter of the driving drum and is greater than a diameter of the rotor shaft.

11. A driving drum unit for a belt drive system, the driving drum unit comprising:
a driving drum; and
a drum shaft, which is configured to be connected to the driving drum and configured to be mounted at both ends of the driving drum and connectable to a bearing-free rotor shaft of a gearless drive, and wherein the drum shaft has a hollow shaft which is connectable to the rotor shaft by an end face which faces the rotor shaft, and wherein the end face has an outside diameter which is a same size or smaller than an outside diameter of the hollow shaft.

12. The driving drum unit as claimed in claim 11, wherein, close to the hollow shaft, the drum shaft comprises:
a connecting shaft produced from solid material with a smaller diameter than the outside diameter of the hollow shaft, and wherein the hollow shaft and the drum shaft are connected together on an end of the hollow shaft which is remote from the rotor shaft, and wherein a drum shaft bearing on the rotor shaft end is configured to guide the hollow shaft and a drum shaft bearing which is remote from the rotor shaft is configured to guide the connecting shaft.

13. The driving drum unit as claimed in claim 11, wherein the hollow shaft comprises:
a circular reinforcement in a region of the connection to the rotor shaft.

14. The driving drum unit as claimed in claim 13, wherein the reinforcement forms at least in part the end face of the hollow shaft which faces the rotor shaft.

15. The driving drum unit as claimed in claim 11, wherein the outside diameter of the hollow shaft is smaller than an outside diameter of the driving drum and is greater than a diameter of the rotor shaft.
